(19) United States
(12) Patent Application Publication
(10) Pub. No.: US 2025/0162561 A1
(43) Pub. Date: May 22, 2025

(54) SNAP TYPE RETAINER FOR BALL RETURN OF BALL NUT

(71) Applicant: HL MANDO CORPORATION, Gyeonggi-do (KR)

(72) Inventors: Troy STRIETER, Bay City, MI (US); Jeff LAUMAN, Bay City, MI (US); Matthew DOLL, Bay City, MI (US); Victor DAHN, Bay City, MI (US); Connor STARK, Bay City, MI (US)

(21) Appl. No.: 18/513,514

(22) Filed: Nov. 18, 2023

(51) Int. Cl. B60T 13/74; F16H 25/22

(52) U.S. Cl. CPC B60T 13/746; F16H 25/2228

(57) ABSTRACT

A retainer comprises a snap ring part substantially discontinuous-ring shaped with opposed ends defining a break to be fitted over an outer surface of a ball nut; and an outer race part of a ball return formed on an inner surface of the snap ring part to be coupled with an inner race part of the ball return, end portions of the outer race part of the ball return to be connected to openings of the ball nut for recirculating balls. The snap ring part is extended further than the end portions of the outer race part of the ball return around the outer surface of the ball nut such that the snap ring part retains the outer race part, formed on the inner surface of the retaining ring portion, on the outer surface of the ball nut to be coupled with the inner race part of the ball return.

### BACKGROUND

Various embodiments of the present disclosure relate in general to the field of ball nut and screw assemblies, and more particularly, to a ball return connected to a ball nut for repeatedly circulating balls.

Ball nut and screw assemblies are widely used in industry for translating rotary motion into linear motion or vice versa. Thus, they are employed in actuators in various applications including automobiles, machine tools, aircraft controls, and so on. The ball nut and screw assemblies typically include a ball return tube for returning balls from one end to another end of a ball nut. Commonly, the ball return tube is secured by a clip screwed or attached to the ball nut, which may increase complexity and cost of assembling the ball nut and screw assembly.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to some embodiments of the present disclosure, a retainer may comprise: a snap ring part substantially discontinuous-ring shaped with opposed ends defining a break to be fitted over an outer surface of a ball nut; and an outer race part of a ball return formed on an inner surface of the snap ring part to be coupled with an inner race part of the ball return, end portions of the outer race part of the ball return to be connected to openings of the ball nut for recirculating balls.

The snap ring part may be extended further than at least one of the end portions of the outer race part of the ball return around the outer surface of the ball nut such that the snap ring part retains the outer race part of the ball return, formed on the inner surface of the retaining ring portion, on the outer surface of the ball nut to be coupled with the inner race part of the ball return.

The snap ring part may encircle around more than a half of the outer surface of the ball nut.

The end portions of the outer race part of the ball return may protrude from the inner surface of the snap ring part toward the openings of the ball nut such that the end portions of the outer race part of the ball return are inserted to the openings of the ball nut.

The outer race part of the ball return formed on the inner surface of the snap ring part may comprise at least one of a groove, recess or rail for guiding circulation of the balls.

The retainer may further comprise the inner race part of the ball return coupled with the outer race part of the ball return formed on the inner surface of the snap ring part.

The inner race part of the ball return may be formed on the outer surface of the ball nut.

The inner race part of the ball return formed on the outer surface of the ball nut may have a groove or recess for guiding circulation of the balls

The end portions of the snap ring part may be configured to be expandable such that the snap ring part is snapped onto the outer surface of the ball nut through the break defined by the end portions of the snap ring part.

The snap ring part may be made of elastically deflectable material.

A distance between the end portions of the snap ring part may be shorter than a diameter of the ball nut.

An inner diameter of the snap ring part may be equal to or greater than a diameter of the ball nut.

A surface of one of the end portions of the snap ring part may be slanted with respect to an inner circumferential surface of the snap ring part such that an angle between the surface of one of the end portions of the snap ring part and the inner circumferential surface of the snap ring part is greater than 90 degrees.

The inner race part of the ball return and an inner race of a bearing rotatably supporting the ball nut may be integrally formed on the outer surface of the ball nut.

According to certain embodiments of the present disclosure, a brake assembly may comprise: a ball nut configured to be rotatable by an actuator, the ball nut comprising an inner race part of a ball return and openings for recirculating balls; a ball screw operably coupled with the ball nut, the ball screw configured to be axially translatable relative to the ball nut to move a brake pad according to rotation of the ball nut; and a retainer comprising a snap ring part substantially discontinuous-ring shaped with opposed ends defining a break to be fitted over an outer surface of the ball nut, and an outer race part of the ball return formed on an inner surface of the snap ring part and coupled with the inner race part of the ball nut to form the ball return, wherein end portions of the outer race part of the ball return are connected to the openings of the ball nut for recirculating the balls.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a cross-sectional view of a brake assembly according to an exemplary embodiment of the present disclosure.

FIG. 2A is a top view of a ball nut and a bearing assembly according to an exemplary embodiment of the present disclosure.

FIG. 2B is a cross-sectional view of a ball nut and a bearing assembly according to an exemplary embodiment of the present disclosure.

FIG. 3A is a perspective view of a snap type retainer according to an exemplary embodiment of the present disclosure.

FIG. 3B is a side view of a snap type retainer according to an exemplary embodiment of the present disclosure.

FIG. 3C is a bottom view of a snap type retainer according to an exemplary embodiment of the present disclosure.

FIG. 3D is a cross-sectional view cut along line A-A of FIG. 3C according to an exemplary embodiment of the present disclosure.

FIG. 4A is a perspective and partial transparent view of a ball screw assembly with a snap type retainer according to an embodiment of the present disclosure.

FIG. 4B is another perspective view of a ball screw assembly with a snap type retainer according to an embodiment of the present disclosure.

FIG. 4C is still another perspective view of a ball screw assembly with a snap type retainer according to an embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

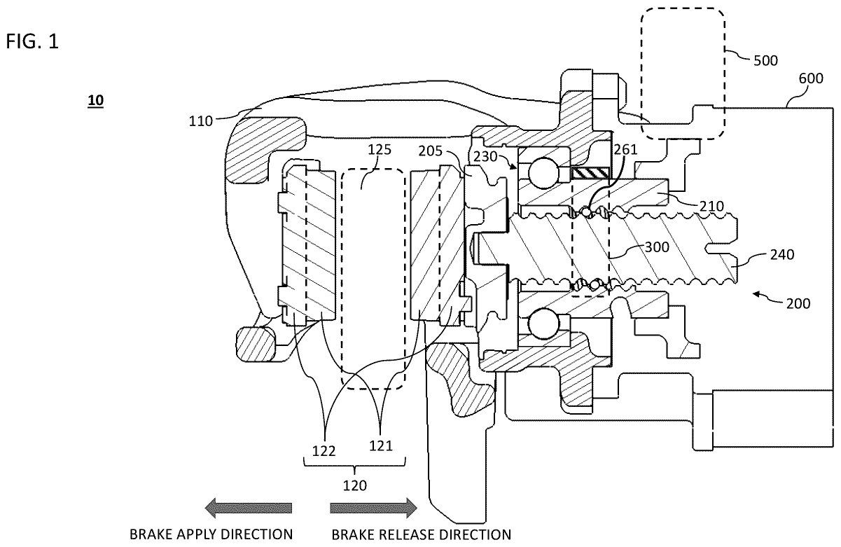

Referring to FIG. 1, a brake assembly 10 may include a brake caliper 110. The brake caliper 110 may be mounted in a floating manner by means of a brake carrier. The brake caliper 110 may be connected to any non-rotating or non-moving part of a vehicle. When the vehicle is in motion, a brake rotor 125 may rotate with a wheel about an axle of the vehicle. A brake pad assembly (or brake lining assembly) 120 is provided in the brake caliper 110, and includes a brake pad or lining 121 and a brake pad (or lining) carrier 122. The brake caliper 110 may include a bridge with fingers, and the fingers of the brake caliper 110 may be in contact with the brake pad carrier 122. The brake pad 121 is disposed with a small air clearance on a side of the brake rotor 125, such as a brake disc, in a release position so that no significant residual drag moment occurs. The brake pad carrier 122 is disposed between the brake pad 121 and a brake pad footing 205, the brake pad 121 and the brake pad carrier 122 of the brake assembly 120 move jointly together, and the movement of the brake pad carrier 122 causes the brake pad 121 to move with respect to the brake rotor 125.

The brake assembly 10 may be, for example, but not limited to, an electro-mechanical brake (EMB) type system that is actuated by electrical energy. The EMB system generally provides braking of a vehicle by the use of a motor which becomes selectively energized in response to a signal of an electronic control unit (ECU) or a sensed depression of a brake input means. The present disclosure is not limited to the EMB type system. A snap type retainer 300 for ball return described later according to some exemplary embodiments of the present disclosure can be applied to any type brake assembly having a ball nut mechanism.

The brake assembly 10 may comprise a ball nut mechanism 200 configured to convert rotary motion generated by an actuator assembly 500 into linear motion in order to move the brake pad assembly 120 toward or away from the brake rotor 125 in an axial direction.

The ball nut mechanism 200 may include a ball nut 210 and a ball screw 240. The ball nut mechanism 200 may be contained within a housing 600. The ball nut 210 and the ball screw 240 may be concentrically mounted in a cavity formed by an inner wall of the housing 600. The housing 600 may be fixedly coupled with the brake caliper 110.

The ball nut 210 is operably coupled to the actuator assembly 500, and is configured to be rotatable by actuation of the actuator assembly 500. For example, the ball nut 210 is directly or indirectly coupled to the actuator assembly 500 through one or more gears and/or belts, any other connecting means and combination thereof. The actuator assembly 500 may comprise a motor fixedly mounted in the housing 600 or disposed outside the housing 600. Examples of the actuator assembly 500 and other parts of the brake assembly 10 are provided in U.S. patent application Ser. No. 17/575,628, entitled “BRAKE ASSEMBLY WITH TELESCOPIC MULTIPLE BALL SCREW MECHANISM”, filed on Jan. 13, 2022, which is incorporated herein by reference in its entirety.

The actuator assembly 500 rotates the ball nut 210 of the ball nut mechanism 200, and then the ball nut mechanism 200 converts the rotary motion of the ball nut 210 to the linear motion of the brake pad footing 205 to move the brake pad assembly 120 between its brake apply and release positions. For example, the actuation of the actuator 500 causes the ball nut 210 to rotate, and the rotation of the ball nut 210 causes the ball screw 240 to be linearly moved. Specifically, the ball nut 210 can rotate relative to the housing 600, and the rotation of the ball nut 210 relative to the housing 600 causes to the ball screw 240 advance or retract axially depending on a direction of rotation of the ball nut 210. As the ball nut 210 rotates in an expanding direction, the ball screw 240 linearly translates with respect to the ball nut 210 and the housing 600 so that the ball screw 240 can translate out from the ball nut 210 and the housing 600 towards the brake rotor 125. As the ball nut 210 rotates in a collapsing direction, the ball screw 240 linearly translates with respect to the ball nut 210 and the housing 600 so that the ball screw 240 can linearly move toward the ball nut 210 and the housing 600 in a direction away from the brake rotor 125. The brake pad footing 205 is fixedly coupled to the ball screw 240 so that the brake pad footing 205 can be linearly movable together with the ball screw 240. When the ball nut mechanism 200 is in the expanded state, the brake pad footing 205 pushes the brake pad assembly 120 toward the brake rotor 125. When the ball nut mechanism 200 is in the collapsed state, the brake pad footing 205 moves away from the brake rotor 125.

While the expanding or collapsing direction depends upon whether the ball nut 210 and the ball screw 240 are left-handed or right-handed, a specific direction is not critical to some embodiments of the present disclosure, and most embodiments of the present disclosure can work with either.

The bearing assembly 230 is configured to rotatably support the ball nut mechanism 200. The bearing assembly 230 may be positioned between the ball nut 210 and a non-rotating structure, for example, but not limited to, the housing 600. The bearing assembly 230 is used to rotatably support the ball nut 210 for rotation relative to a non-rotating structure of the brake assembly 10. The bearing assembly 230 may have an inner race 231, an outer race (or an outer ring) 232, and a plurality of rollable bodies 233 (e.g., bearing balls). The bearing assembly 230 may include any number of rollable bodies 233, for example, more than four balls. The outer race 232 may be located concentrically about the inner race 231, with the rollable bodies 233 therebetween, in a plane generally perpendicular to a rotatable axis of the ball nut 210 or the inner race 231 or a translatable axis of the ball screw 240. The inner race 231 is rotatable, but the outer race 232 is substantially non-rotatable. The inner race 231 defines an inner circumferential surface, and is provided on the outside of the ball nut 210. The inner race 231 may be directly formed on, or fixed to, the outer surface of the rotatable part 210. The outer race (or an outer ring) 232 may be fixed to a non-rotating structure of the brake assembly 10.

The ball nut 210 may have a tubular shape with axially open ends, and the ball screw 240 is received within an inside space of the ball nut 210. The ball nut 210 and the ball screw 240 are operably connected to each other such that while the ball nut 210 rotates, the ball screw 240 is linearly movable relative to the ball nut 210. In other words, the ball screw 240 is slidable with respect to the ball nut 210, but the ball screw 240 cannot be rotatable relative to the ball nut 210, and therefore as the ball nut 210 rotates, the ball screw 240 is linearly moved. For example, the ball screw 240 has a structure configured to prevent the ball screw 240 from rotating relative to the ball nut 210 while allowing the ball screw 240 to translate in the axial direction.

At least a part of the ball screw 240 is retained within the ball nut 210. The ball nut 210 has an internally-threaded track groove and the ball screw 240 has an externally-threaded track groove for a rollable body arrangement of rollable bodies 261 (e.g. balls). The balls 261 may be metal spheres which decrease friction and transfer loads between adjacent components. The balls 261 are loaded into the ball nut assembly 200. Specifically, the balls 261 are disposed between the internally-threaded track groove of the rotatable part 210 and the externally-threaded track groove of the translatable part 240. The ball nut 210 is rotatably supported by the ball screw 240 via the balls 261.

The internally-threaded track groove of the ball nut 210 and the externally-threaded track groove of the ball screw 240 form a series of ball tracks to provide a helical raceway for reception of a train of recirculating the balls 261. A ball return 305 carries the balls 261 from the end of their path back to the beginning to complete their recirculating track. An outer race part 310 and an inner race part 220 coupled to each other can form the ball return tunnel 305 to perform recirculation of the balls 261.

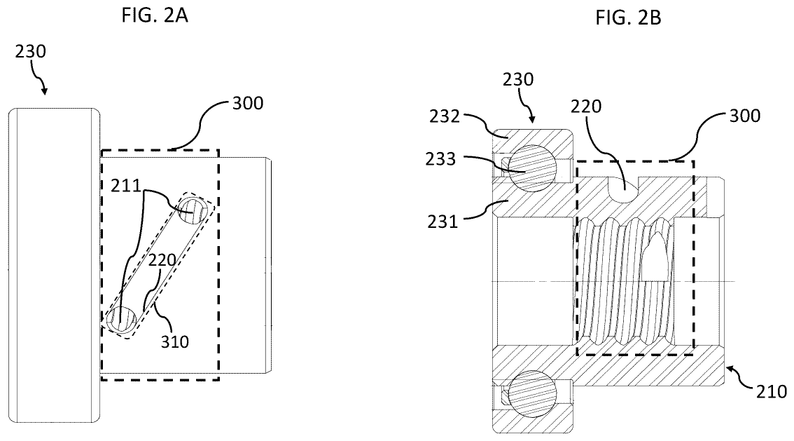

As illustrated in FIG. 2B, the inner race part 220 of the ball return 305 may be integrally formed on the outer surface of the ball nut 210. For example, the inner race part 220 of the ball return 305 can be formed by machining or molding a groove or recess on the outer surface of the ball nut 210. Alternatively, the inner race part 220 of the ball return 305 may have a separate structure from the ball nut 210, and may be disposed on or fixed to the outer surface of the ball nut 210.

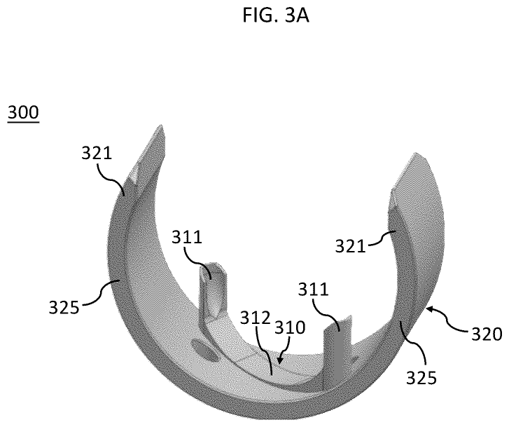

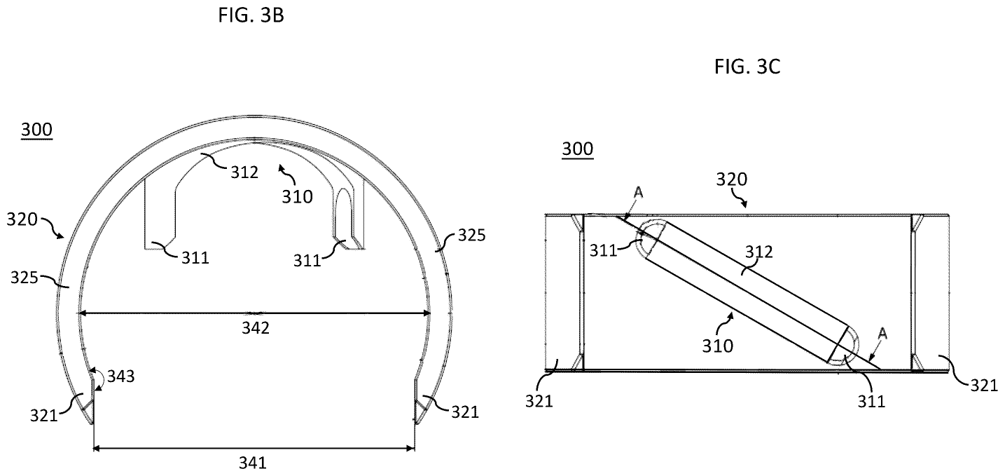

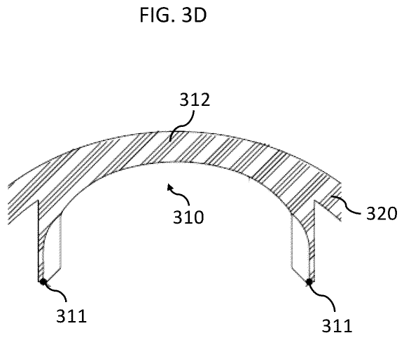

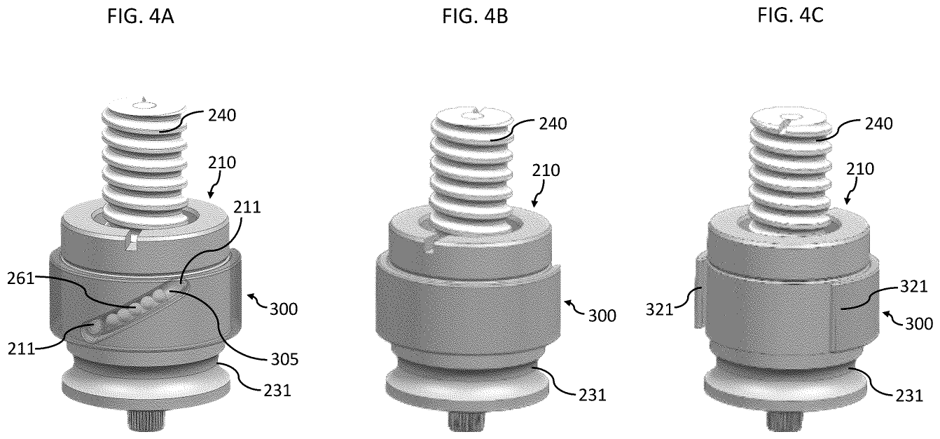

Referring to FIGS. 3A to 3D, the snap type retainer 300 may include the outer race part 310 for the ball return 305 and the snap ring part 320 for retaining the outer race part 310 on the ball nut 210. The outer race part 310 may be integrated with the snap ring part 320 as one single piece, thereby providing a simpler assembly process and reducing manufacturing cost.

The outer race part 310 of the ball return 305 may be formed on an inner surface of the snap ring part 320. The end portions 311 of the outer race part 310 of the ball return 305 protrude from the inner surface of the snap ring part 320 toward openings 211 of the ball nut 210 such that the end portions 311 of the outer race part 310 of the snap type retainer 300 can be inserted to the openings 211 of the ball nut 210 to form a recirculating track of the balls 261 together with the inner race part 220 formed or provided on the outer surface of the ball nut 210. By inserting the end portions 311 of the outer race part 310 protruding from the inner surface of the snap ring part 320 into the openings 211 of the ball nut 210, the outer race part 310 formed on the inner surface of the snap ring part 320 can be securely coupled to the ball nut 210 and the movement of the snap type retainer 300 can be restricted.

When the snap type retainer 300 is snapped on the ball nut 210, the outer race part 310 formed on the inner surface of the snap ring part 320 is coupled with the inner race part 310 formed or disposed on the outer surface of the ball nut 210 to form the ball return 305. The ball return 305 formed by the inner race part 220 and the outer race part 310 connects two openings 211 of the ball nut 210 to circulate the balls 261. The balls 261 repeatedly circulate between the ball nut 210 and the ball screw 240, through one of the openings 211 of the ball nut 210, through the ball return tunnel 305 formed by the inner race part 220 and the outer race part 310, and through the other of the opening 211 of the ball nut 210, and back between the ball nut 210 and the ball screw 240. The balls 261 may also circulate through the ball return 305 from one to the other of the openings 211 of the ball nut 210.

A middle portion 312 between the end portions 311 of the outer race part 310 may be configured to guide the movement or circulation of the balls 261 to form a ball recirculation path. For example, the middle portion 312 of the outer race part 310 may have a recess, groove, or rail so that the balls 261 can move along it. However, the middle portion 312 of the outer race part 310 may have any shape which is capable of guiding the recirculating movement of the balls 261 to return the balls 261 from one to the other of the openings 211 of the ball nut 210.

The snap type retainer 300 is snapped and mounted on the outer surface of the ball nut 210 to couple the outer race part 310, formed on the inner surface of the ball nut 210, to the inner race part 220, formed or provided on the outer surface of the ball nut 210. The outer race part 310 of the ball return 305 can be secured to the ball nut 210 by the snap ring part 320. The outer race part 310 and the snap ring part 320 are unitarily formed as one piece.

The snap ring part 320 may be substantially discontinuous-ring shaped with opposed ends 321 defining an opening to be fitted over the outer surface of the ball nut 210. The snap ring part 320 has an annular main body which forms a discontinuous ring that has ends 321 defining a break in the ring. The opposed ends 321 of the snap ring part 320 are configured to be expandable such that the snap type retainer 300 can be snapped and placed onto the outer surface of the ball nut 210 through the opening defined by the opposed ends 321 of the snap ring part 320. A gap between the opposed ends 321 of the snap ring part 320 facilitates flexing of the snap ring part 320 from a nominal state to a flexed or expanded state during the assembly of the snap type retainer 300 to the ball nut 210. For instance, the opposed ends 321 of the snap ring part 320 may be expanded from its nominal state prior to and/or during the installment of the snap type retainer 300 to the ball nut 210. After the assembly of the snap type retainer 300 to the ball nut 210 is completed, the snap ring part 320 returns to the nominal state.

To securely retain the outer race part 310 formed on the inner surface of the snap ring part 320 against the disengagement from the inner race part 220 formed or disposed on the outer surface of the ball nut 210 and prevent the snap type retainer 300 from being disengaged from the ball nut 210, a distance 341 between the opposed ends 321 of the snap ring part 320 is shorter than a diameter of the ball nut 210 (e.g. a maximum outside diameter of the ball nut 210). And, the inner diameter 342 of the snap ring part 320 is equal to or greater than the diameter of the ball nut 210 so that the snap ring part 320 can cover at least a part of the exterior of the ball nut 210.

The snap ring part 320 is extended further than one or both end portions 311 of the outer race part 220 around the outer surface of the ball nut 210 such that the snap ring part 320 can securely retain the outer race part 310, formed on the inner surface of the snap ring part 320, on the outer surface of the ball nut 210 to be coupled with the inner race part 220 formed or disposed on the outer surface of the ball nut 210. For example, the snap ring part 320 can encircle around more than a half of the outer surface of the ball nut 210.

The snap ring part 320 has legs 325 for engagement with the exterior of the ball nut 210. The ball nut 210 is slidably received in between the legs 325 of the snap ring part 320 through the opening defined by the opposed ends 321 of the snap ring part 320. A pair of legs 325 of the snap ring part 320 are bent to encircle the outside of the ball nut 210 and securely hold the ball nut 210. For example, each of the legs 325 of the snap ring part 320 has a semi-circular bent shape to receive the ball nut 210 therebetween.

The legs 325 of the snap ring part 320 are sufficiently resilient so as to flex outwardly to ride over the ball nut 210 as the ball nut 210 is inserted between the pair of legs 325 of the snap ring part 320 to encircle the ball nut 210 with the snap ring part 320. The snap type retainer 300 may be made of elastically deflectable material. For example, it may desirable to form the snap type retainer 300 from a plastic material, for example, nylon or another polyamide. To assemble the snap type retainer 300 to the ball nut 210, the pair of legs 325 of the snap ring part 320 are spread apart up to the diameter of the ball nut 210 in order to allow the ball nut 210 to pass. The snap type retainer 300 will, however, snap back into position to retain the outer race part 310 formed on the inner surface of the snap ring part 320 against disengagement from the ball nut 210. The snap type retainer 300 is resilient biased against separation from the ball nut 210 so as to keep the outer race part 310 formed on the inner surface of the snap ring part 320 in position.

A surface of the end portion 321 of the snap type retainer 300 is slanted with respect to an inner circumferential surface of the snap ring part 320 such that an angle 343 between the surface of the end portion 321 of the snap ring part and an inner circumferential surface of the snap ring part 320 is greater than 90 degrees in order to easily receive the ball nut 210 in between the legs 325 of the snap ring part 320 during the assembly of the snap type retainer 300.

According to some embodiments of the present disclosure, the snap ring part 320 is integrated with the outer race part 310 of the ball return 305 so that the snap type retainer 300 can securely retain the outer race part 310 of the ball return 305 in position against disengagement from the ball nut 210, thereby ensuring manufacturability, ease of assembly, reduced mass, reduced complexity, fewer parts, and providing for ease of assembly.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A retainer comprising:
a snap ring part substantially discontinuous-ring shaped with opposed ends defining a break to be fitted over an outer surface of a ball nut; and
an outer race part of a ball return formed on an inner surface of the snap ring part to be coupled with an inner race part of the ball return, end portions of the outer race part of the ball return to be connected to openings of the ball nut for recirculating balls.

2. The retainer according to claim 1, wherein the snap ring part is extended further than at least one of the end portions of the outer race part of the ball return around the outer surface of the ball nut such that the snap ring part retains the outer race part of the ball return, formed on the inner surface of the retaining ring portion, on the outer surface of the ball nut to be coupled with the inner race part of the ball return.

3. The retainer according to claim 1, wherein the snap ring part encircles around more than a half of the outer surface of the ball nut.

4. The retainer according to claim 1, wherein the end portions of the outer race part of the ball return protrude from the inner surface of the snap ring part toward the openings of the ball nut such that the end portions of the outer race part of the ball return are inserted to the openings of the ball nut.

5. The retainer according to claim 1, wherein the outer race part of the ball return formed on the inner surface of the snap ring part comprises at least one of a groove, recess or rail for guiding circulation of the balls.

6. The retainer according to claim 1, further comprising the inner race part of the ball return coupled with the outer race part of the ball return formed on the inner surface of the snap ring part.

7. The retainer according to claim 1, wherein the inner race part of the ball return is formed on the outer surface of the ball nut.

8. The retainer according to claim 1, wherein the inner race part of the ball return formed on the outer surface of the ball nut has a groove or recess for guiding circulation of the balls

9. The retainer according to claim 1, wherein the end portions of the snap ring part are configured to be expandable such that the snap ring part is snapped onto the outer surface of the ball nut through the break defined by the end portions of the snap ring part.

10. The retainer according to claim 1, wherein the snap ring part is made of elastically deflectable material.

11. The retainer according to claim 1, wherein a distance between the end portions of the snap ring part is shorter than a diameter of the ball nut.

12. The retainer according to claim 1, wherein an inner diameter of the snap ring part is equal to or greater than a diameter of the ball nut.

13. The retainer according to claim 1, wherein a surface of one of the end portions of the snap ring part is slanted with respect to an inner circumferential surface of the snap ring part such that an angle between the surface of one of the end portions of the snap ring part and the inner circumferential surface of the snap ring part is greater than 90 degrees.

14. A brake assembly comprising:
a ball nut configured to be rotatable by an actuator, the ball nut comprising an inner race part of a ball return and openings for recirculating balls;
a ball screw operably coupled with the ball nut, the ball screw configured to be axially translatable relative to the ball nut to move a brake pad according to rotation of the ball nut; and
a retainer comprising a snap ring part substantially discontinuous-ring shaped with opposed ends defining a break to be fitted over an outer surface of the ball nut, and an outer race part of the ball return formed on an inner surface of the snap ring part and coupled with the inner race part of the ball nut to form the ball return, wherein end portions of the outer race part of the ball return are connected to the openings of the ball nut for recirculating the balls.

15. The brake assembly according to claim 14, wherein the snap ring part of the retainer is extended further than at least one of the end portions of the outer race part of the ball return around the outer surface of the ball nut such that the snap ring part of the retainer retains the outer race part of the ball return, formed on the inner surface of the retaining ring portion, on the outer surface of the ball nut to be coupled with the inner race part of the ball return.

16. The brake assembly according to claim 14, wherein the snap ring part of the retainer encircles around more than a half of the outer surface of the ball nut.

17. The brake assembly according to claim 14, wherein the end portions of the outer race part of the ball return protrude from the inner surface of the snap ring part toward the openings of the ball nut such that the end portions of the outer race part of the ball return are inserted to the openings of the ball nut.

18. The brake assembly according to claim 14, wherein a distance between the end portions of the snap ring part is shorter than a diameter of the ball nut.

19. The brake assembly according to claim 14, wherein an inner diameter of the snap ring part is equal to or greater than a diameter of the ball nut.

20. The brake assembly according to claim 14, wherein the inner race part of the ball return and an inner race of a bearing rotatably supporting the ball nut are integrally formed on the outer surface of the ball nut.
